(19) United States
(12) Patent Application Publication
(10) Pub. No.: US 2001/0055294 A1
(43) Pub. Date: Dec. 27, 2001

(54) CDMA communication system capable of flexibly assigning spreading codes to a channel in accordance with traffic

(75) Inventor: Gen Motoyoshi, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/888,393

(22) Filed: Jun. 26, 2001

(30) Foreign Application Priority Data
Jun. 27, 2000 (JP) 2000-193317

(51) Int. Cl. H04B 7/216

(52) U.S. Cl. 370/342; 370/335; 370/441; 375/132

(57) ABSTRACT

In a CDMA communication system using a common frequency band at a forward channel and a reverse channel, a first detection section detects traffic in the reverse channel to produce a first detected signal indicative of the traffic in the reverse channel. A first assigning section (131) assigns reverse spreading codes to the reverse channel. The first assigning section (132) makes, in response to the first detected signal, number of the reverse spreading codes change. A second detection section (231) detects traffic in the forward channel to produce a second detected signal indicative of the traffic in the forward channel. A second assigning section (232) assigns forward spreading codes to the forward channel. The second assigning section makes, in response to the second detected signal, number of the forward spreading code change.

### BACKGROUND OF THE INVENTION

This invention relates to a code division multiple access (CDMA) communication system and a CDMA communication method.

As a cellular mobile radio communication system, a wide variety of multiple access systems have been heretofore proposed and be adopted in the world. Among others, a recent tendency has been directed to a cellular mobile radio code division multiple access (CDMA) communication system which has a specific spreading code assigned to each channel and which will be simply called a CDMA communication system. In such a CDMA communication system, a modulated wave of an identical carrier frequency which is spread by each specific spreading code is transmitted as a radio signal from a transmitter side to a receiver side. Responsive to the radio signal, a CDMA receiver in the receiver side carries out synchronization operation by the use of each specific spreading code to identify a desired channel. In order to distinguish the channels from one another, different spreading codes are used to identify radio channels between the base station and the mobile stations.

In the manner known in the art, the CDMA communication systems are classified roughly into direct sequence (DS) systems and frequency hopping (FH) system. Specifically, inasmuch as the frequency hopping system has a frequency diversity effect, the frequency hopping system is advantageous in that it is strong for frequency selective fading. In the direct sequence system and the frequency hopping system, channels between the mobile stations are separated by using the spreading codes which are orthogonal to one another.

On the other hand, in data communications popularly carried out in recent years with spreading the Internet, forward traffic in a forward channel is generally larger than reverse traffic in a reverse channel. With respect to the above-mentioned frequency hopping system, Japanese Granted Patent Publication of Tokkyo No. 2,812,318 or JP-B 2812318 discloses “SPREAD SPECTRUM COMMUNICATION METHOD AND DEVICE” to attain the communication with high reliability enhancing the frequency diversity effect even when affected by frequency selective fading or the like by taking deterioration in channels into account so as to uniformalize the line capacity. According to JP-B 2812318, between a base station and a mobile station in a CDMA system employing a frequency hopping system changing a hopping frequency with a hopping series depending on each channel and multiplexing data, a same frequency band is used between forward and reverse channels and number of assigned hopping frequencies and/or number of hopping per one data symbol are changed between the forward and the reverse channels based on channel quality. Then different hopping frequencies are used multiplex data and to make transmission and reception between the forward and the reverse channels thereby making communication.

Although the system disclosed in JP-B 2812318 is effective in a communication system where traffic is biased in the forward channel such as the data communication, the system disclosed in JP-B 2812318 is disadvantageous in that the channel having a narrow used channel band width is affected by the frequency selective fading.

In addition, various other prior arts related to the present invention are already known. By way of example, Japanese Unexamined Patent Publication of Tokkai No. Hei 6-104,865 or JP-A 6-10465 discloses “CDMA TIME-DIVISION MUTIPLEX COMMUNICATION SYSTEM” in which the same carrier frequency is used for a forward channel and a reverse channel to apply time division multiplex processing to the signal with respect to the CDMA communication system employing the spread spectrum communication system. According to JP-A 6-104865, a same carrier frequency is used for the forward channel and the reverse channel between a mobile station and a base station in the CDMA system employing the spread spectrum communication system in which spread spectrum processing is implemented by using a different spread code string different from each channel and multiplexed. The base station and the mobile station make alternate transmission reception by time division multiplexing for the communication.

However, JP-A 6-10465 merely discloses the CDMA time-division multiplex communication system.

Japanese Unexamined Patent Publication of Tokkai No. Hei 9-312,885 or JP-A 9-312885 discloses “MOBILE COMMUNICATION METHOD, BASE STATION EQUIPMENT AND MOTILE STATION EQUIPMENT” to provide a code division multiplex access (CDMA) system in which a spreading code for a perch channel is not increased in the case of increasing number of sectors, control traffic is not pressed and a capacity increase effect due to sector processing is obtained. According to JP-A 9-312885, each sector in a same base station makes transmission through a perch channel spread by a spread code assigned to each of base stations an in the case of making simultaneous reception by two sectors or over in the same base station. Signals received by the two sectors or over are subject to despread by using the same incoming spread code and subject to maximum ratio synthesis. In the case of making transmission simultaneously from the two sectors or over in the same base station, signals spread by the same outgoing spread code are sent from the two sectors or over.

However, in JP-A 9-312885 merely discloses the CDMA communication system which is capable of preventing number of spreading codes for a perch channel from increasing although number of sectors is increased.

SUMMARY OF THE INVENTION

It is an object of this invention to provide a CDMA communication system which is capable of promoting practical use of resources.

It is another object of this invention to provide a CDMA communication system of the type described, which is unaffected by frequency selective fading.

It is still another of this invention to provide a CDMA communication system of the type described, which enables channel assignment in accordance with traffic capacity of a used channel.

Other objects of this invention will become clear as the description proceeds.

According to an aspect of this invention, a CDMA communication system using a common frequency band at a forward channel and a reverse channel. The CDMA communication system comprises a first detecting arrangement for detecting traffic in the reverse channel to produce a first detected signal indicative of the traffic in the reverse channel. A first assigning arrangement assigns reverse spreading codes to the reverse channel. The first assigning arrangement makes, in response to the first detected signal, the number of the reverse spreading codes change. A second detecting arrangement detects traffic in the forward channel to produce a second detected signal indicative of the traffic in the forward channel. A second assigning arrangement assigns forward spreading codes to the forward channel. The second assigning arrangement makes, in response to the second detected signal, the number of the forward spreading code change.

In the above-mentioned CDMA communication system, the CDMA communication system may be a frequency hopping system or a direct sequence system. The first assigning arrangement preferably may increase number of the reverse spreading codes when the traffic in the reverse channel is much. The first assigning arrangement preferably may decrease the number of the reverse spreading codes when the traffic in the reverse channel is little. The second assigning arrangement desirably may increase number of the forward spreading codes when the traffic in the forward channel is much. The second assigning arrangement desirably may decrease the number of the forward spreading codes when the traffic in the forward channel is little.

According to another aspect of this invention, a CDMA communication method uses a common frequency band at a forward channel and a reverse channel. The CDMA communication method comprising the steps of detecting traffic in the reverse channel to produce a first detected signal indicative of the traffic in the reverse channel, of assigning reverse spreading codes to the reverse channel to make, in response to the first detected signal, number of the reverse spreading codes change, of detecting traffic in the forward channel to produce a second detected signal indicative of the traffic in the forward channel, and of assigning forward spreading codes to the forward channel to make, in response to the second detected signal, number of the forward spreading code change.

In the above-mentioned CDMA communication method, the CDMA communication method may be carried out in a frequency hopping system or in a direct sequence system. The step of assigning the reverse spreading codes preferably may increase number of the reverse spreading codes when the traffic in the reverse channel is much. The step of assigning the reverse spreading codes preferably may decrease the number of the reverse spreading codes when the traffic in the reverse channel is little. The step of assigning said forward spreading codes desirably may increase number of the forward spreading codes when the traffic in the forward channel is much. The step of assigning the forward spreading codes desirably may decrease the number of the forward spreading codes when the traffic in the forward channel is little.

### BRIEF DESCRIPTION OF THE DRAWINGS

FIG. 1 shows hopping frequencies assigned to forward and reverse channels in a conventional CDMA communication system;

FIG. 2 shows spreading codes assigned to forward and reverse channels in a CDMA communication system according to an embodiment of this invention.

FIG. 3 shows a block diagram of a CDMA communication system according to an embodiment of this invention;

FIG. 4 shows a block diagram of a mobile control section for use in the CDMA communication system illustrated in FIG. 3; and

FIG. 5 shows a block diagram of a base control section for use in the CDMA communication system illustrated in FIG. 3.

### DESCRIPTION OF THE PREFERRED EMBODIMENT

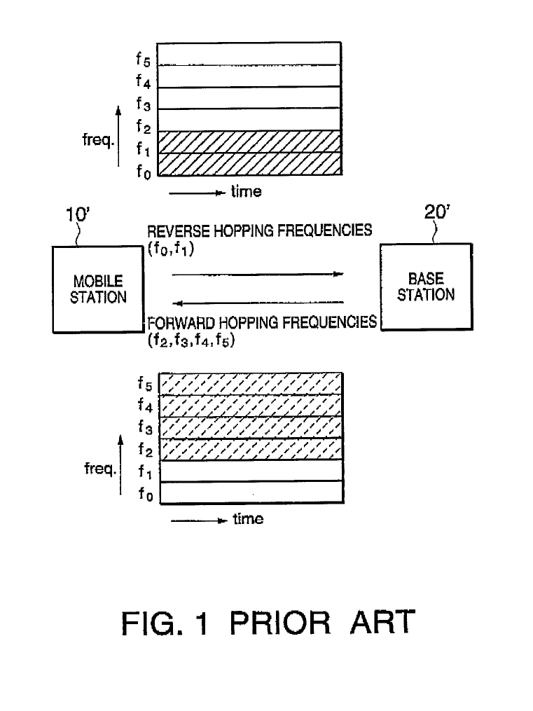

Referring to FIG. 1, a conventional CDMA (code division multiple access) communication system will be described at first in order to facilitate an understanding of the present invention. The illustrated CDMA communication system comprises a mobile station 10′ and a base station 20′ . The CDMA communication system uses a same frequency band at forward and reverse channels. In the example being illustrated, the same frequency band consists of zeroth through fifth hopping frequencies f0), f1, f2, f3, f4, and f5. The zeroth and the first hopping frequencies f0 and f1 are used at the reverse channel as reverse hopping frequencies while the second through the fifth hopping frequencies f2 to f5 are used at the forward channel as forward hopping frequencies. That is, the reverse channel is assigned with the reverse hopping frequencies while the forward channel is assigned with the forward hopping frequencies. In addition, the reverse hopping frequencies and the forward hopping frequencies are different from each other.

With this structure, the reverse channel has a narrow band width. As a result, the conventional CDMA communication system is disadvantageous in that the reverse channel is affected by the frequency selective fading, as mentioned in the preamble of the instant specification.

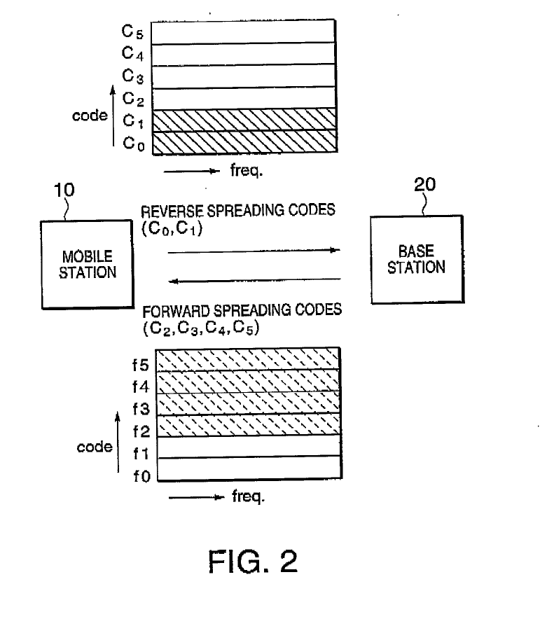

Referring to FIG. 2, the description will proceed to a CDMA communication system according to an embodiment of this invention. The illustrated CDMA communication system comprises a mobile station 10 and a base station 20. The CDMA communication system uses a common frequency band at forward and reverse channels.

In the example being illustrated, the CDMA communication system is assigned with zeroth through fifth spreading codes C0, C1, C2, C3, C4, C5, and C6. In addition, the zeroth and the first spreading codes C0 and C1 are assigned to the reverse channel as reverse spreading codes while the second through the fifth spreading codes C2 to C5 are assigned to the forward channel as forward spreading codes. That is, the reverse channel is assigned with the reverse spreading codes while the forward channel is assigned with the forward spreading codes. The reverse spreading codes and the forward spreading codes are different from each other.

The CDMA communication system controls number of usable spreading codes in accordance with traffic in the forward and the reverse channels. As a result, it is possible to secure channel capacity by using a lot of spreading codes for the channel having much traffic. In addition, it is possible to make good use of resources by using a few spreading codes for the channel having little traffic. In addition, the CDAM communication system carries out frequency hopping.

Accordingly, the CDMA communication system is advantageous in that it is possible to realize communication which effectively promotes practical use of the resources in a system in which bias is predicted for traffic at the forward and the reverse channels of data communication or the like.

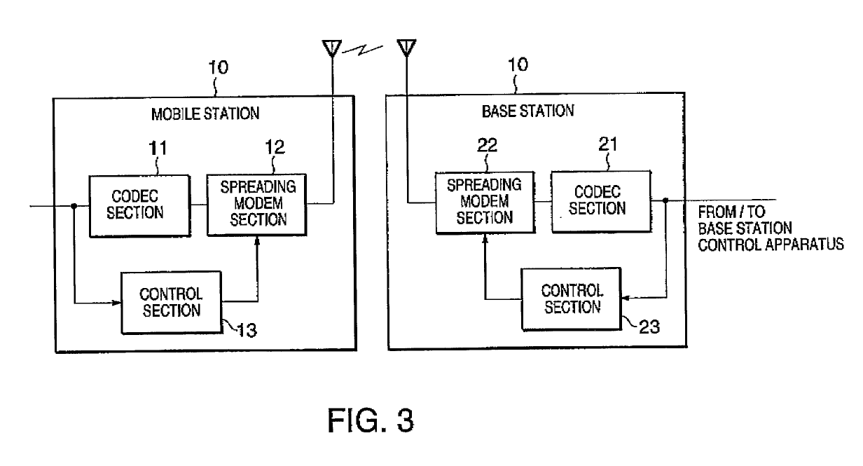

Referring to FIG. 3, the description will proceed to the mobile station 10 and the base station 20.

The mobile station 10 comprises a mobile CODEC section 11, a mobile spreading modem section 12, and a mobile control section 13. The base station 20 comprises a base CODEC section 21, a base spreading modem section 22, and a base control section 23.

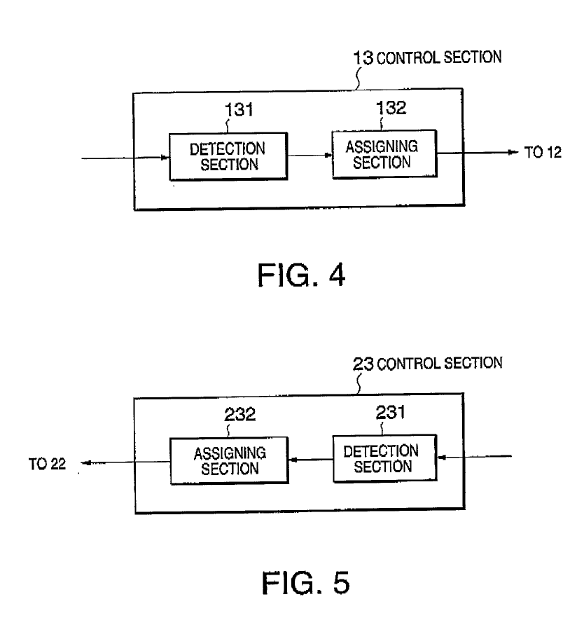

Turning to FIG. 4, the mobile control section 13 comprises a mobile detection section 131 and a mobile assigning section 132. The mobile detection section 131 detects reverse traffic in the reverse channel to produce a reverse traffic detected signal indicative of the reverse traffic. The mobile assigning section 132 assigns, in response to the reverse traffic detected signal, the reverse channel with the reverse spreading codes. That is, responsive to the reverse traffic detected signal, the mobile assigning section 132 makes number of the reverse spreading codes change. More specifically, the mobile assigning section 132 increases the number of the reverse spreading codes for assigning to the reverse channel when the reverse traffic is much. The mobile assigning section 132 decreases the number of the reverse spreading codes for assigning to the reverse channel when the reverse traffic is little.

Turning to FIG. 5, the base control section 23 comprises a base detection section 231 and a base assigning section 232. The base detection section 232 detects forward traffic in the forward channel to produce a forward traffic detected signal indicative of the forward traffic. The base assigning section 232 assigns, in response to the forward traffic detected signal, the forward channel with the forward spreading codes. That is, responsive to the forward traffic detected signal, the base assigning section 232 makes number of the forward spreading codes change. Particularly, the base assigning section 232 increases the number of the forward spreading codes for the forward traffic is much. The base assigning section 232 decreases the number of the forward spreading codes for assigning to the forward channel when the forward traffic is little.

Turning to FIG. 3, the description will be made as regards the forward channel, the base CODEC section 21 is supplied with a forward information signal from a base station control apparatus (not shown). The base CODEC section 21 codes the forward information signal into a forward coded signal which is supplied to the base spreading modem section 22. The base spreading modem section 22 is supplied with the forward spreading codes from the base control section 23. The base spreading modem section 22 spreads the forward coded signal using the forward spreading codes to produce a forward spread signal. The forward spread signal is transmitted from the base station 20 to the mobile station 10.

In addition, the base control station 203 sends, to the base spreading modem section 22, a series of hopping patterns for carrying out frequency hopping and a forward control signal related to the forward spreading codes assigned in accordance with the forward traffic. The series of the hopping patterns and the forward control signal are received in the mobile control section 13 from the base spreading modem section 22 via the mobile spreading modem section 12 and the mobile CODEC section 11.

In the mobile station 10, the mobile CODEC section 11 supplies the series of the hopping patterns and the forward spreading codes to the mobile spreading modem section 12. The mobile spreading modem section 12 receives a forward received signal from the base station 20. The mobile spreading modem section 12 despreads the forward received signal using the forward spreading codes to produce a forward despread signal. The forward despead signal is supplied to the mobile CODEC section 11. The mobile CODEC section 11 decodes the forward despread signal to extract the forward information signal.

The description will be made as regards the reverse channel. The mobile CODEC section 11 is supplied with a reverse information signal. The mobile CODEC section 11 codes the reverse information signal into a reverse coded signal which is supplied to the mobile spreading modem section 12. The mobile spreading modem section 12 is supplied with the reverse spreading codes from the mobile control section 13. The mobile spreading modem section 12 spreads the reverse coded signal using the reverse spreading codes to produce a reverse spread signal. The reverse spread signal is transmitted from the mobile station 10 to the base station 20.

In addition, the mobile control section 13 sends, to the mobile spreading modem section 12, a series of hopping patterns for carrying out frequency hopping and a reverse control signal related to the reverse spreading codes assigned in accordance with the reverse traffic. The series of the hopping patterns and the reverse control signal are received in the base control section 23 from the mobile spreading modem section 12 via the base spreading modem section 22 and the base CODEC section 21

In the base station 20, the base CODEC section 21 supplies the series of the hopping patterns and the reverse spreading codes to the base spreading modem section 22. The base spreading modem section 22 receives a reverse received signal from the mobile station 10. The base spreading modem section 22 despreads the reverse received signal using the reverse spreading codes to produce a reverse despread signal. The reverse despead signal is supplied to the base CODEC section 21. The base CODEC section 21 decodes the reverse despread signal to extract the reverse information signal which is supplied to the base station control apparatus.

Referring to FIGS. 2 and 3, description will be made as regards operation of the CDMA communication system.

The description will at first be made as regards operation in the forward channel. Supplied from the base station control apparatus, the forward information signal is coded by the base CODEC section 21 into the forward coded signal, the forward coded signal is spread by the base spreading modem section 22 into the forward spread signal, and the forward spread signal is transmitted to the mobile station 10. The base spreading modem section 22 uses the forward spreading codes which are supplied from the base control section 23. The base control section 23 determines the forward spreading codes in accordance with the forward traffic in the forward information signal supplied from the base station control apparatus. When the forward traffic is much, the base control section 23 increases the number of the forward spreading codes. When the forward traffic is little, the base control section 23 decreases the number of the reverse spreading codes.

As shown in FIG. 2, the CDMA communication system using the frequency hopping system uses six spreading codes, namely, the zeroth through the fifth spreading codes C0 to C5. The CDMA communication system uses, as the forward spreading codes, the zeroth and the first spreading codes C0 and C1 for the forward channel and uses, as the reverse spreading codes, the second through the fifth spreading codes C2 to C5 for the reverse channel. As a result, the forward channel has a capacity which is twice as large as that of the reverse channel. The CDMA communication system uses the same frequency band at the forward and the reverse channels and carries out the frequency hopping. The series of the hopping patterns is supplied from the base control section 23 to the base spreading modem section 22. The base spreading modem section 22 multiplies the forward coded signal supplied from the base CODED section 21 by the forward spreading codes to produce the forward spread signal which is spread in wide band.

Transmitted from the base station 20, the forward spread signal is received in the mobile station 10 as the forward received signal. The mobile spreading modem section 12 despreads the forward received signal by using the spreading codes which are identical with the forward spreading codes to produce the forward despread signal. The mobile CODEC section 11 decodes the forward despread signal to extract the forward information signal.

The description will be made as regards operation in the reverse channel. The reverse information signal is coded by the mobile CODEC section 11 into the reverse coded signal. The reverse coded signal is spread by the mobile spreading modem section 12 into the reverse spread signal. The reverse spread signal is transmitted to the base station 20. The mobile spreading modem section 12 uses the reverse spreading codes which are supplied from the mobile control section 13. The mobile control section 13 determines the reverse spreading codes in accordance with the reverse traffic in the reverse information signal. When the reverse traffic is much, the mobile control section 13 increases the number of the reverse spreading codes. When the reverse traffic is little, the mobile control section 13 decreases the number of the reverse spreading codes.

Transmitted from the mobile station 10, the reverse spread signal is received in the base station 20 as the reverse received signal. The base spreading modem section 22 despreads the reverse received signal by using the spreading codes which are identical with the reverse spreading codes to produce the reverse despread signal. The base CODEC section 21 decodes the reverse despread signal to extract the reverse information signal.

While this invention has thus far been described in conjunction with an embodiment thereof, it will readily be possible for those skilled in the art to put this invention into practice in various other manners. For example, although the frequency hopping system is used as the CDMA communication system, a direct sequence system may be used as the CDMA communication system. In this event, resistivity of the frequency selective fading increases because wider band transmission is available.

In addition, inasmuch as the CDMA communication system according to the above-mentioned embodiment carries out the frequency hopping, it is possible to provide a system having an increased channel capacity by carrying out repetitive assignment for the spreading codes independent of the hopping frequency and the hopping pattern.

What is claimed is:

1. A code division multiple access (CDMA) communication system using a common frequency band at a forward channel and a reverse channel, said CDMA communication system comprising:
first detecting means for detecting traffic in said reverse channel to produce a first detected signal indicative of the traffic in said reverse channel;
first assigning means for assigning reverse spreading codes to said reverse channel, said first assigning means making, in response to said first detected signal, number of said reverse spreading codes change;
second detecting means for detecting traffic in said forward channel to produce a second detected signal indicative of the traffic in said forward channel; and
second assigning means for assigning forward spreading codes to said forward channel, said second assigning means making, in response to said second detected signal, number of said forward spreading code change.

2. A CDMA communication system as claimed in claim 1, wherein said CDMA communication system is a frequency hopping system.

3. A CDMA communication system as claimed in claim 1, wherein said CDMA communication system is a direct sequence system.

4. A CDMA communication system as claimed in claim 1, wherein said first assigning means increases number of said reverse spreading codes when the traffic in said reverse channel is much, said first assigning means decreasing the number of said reverse spreading codes when the traffic in said reverse channel is little.

5. A CDMA communication system as claimed in claim 1, wherein said second assigning means increases number of said forward spreading codes when the traffic in said forward channel is much, said second assigning means decreasing the number of said forward spreading codes when the traffic in said forward channel is little.

6. A code division multiple access (CDMA) communication method using a common frequency band at a forward channel and a reverse channel, said CDMA communication method comprising the steps of:
detecting traffic in said reverse channel to produce a first detected signal indicative of the traffic in said reverse channel;
assigning reverse spreading codes to said reverse channel to make, in response to said first detected signal, number of said reverse spreading codes change;
detecting traffic in said forward channel to produce a second detected signal indicative of the traffic in said forward channel; and
assigning forward spreading codes to said forward channel to make, in response to said second detected signal, number of said forward spreading code change.

7. A CDMA communication method as claimed in claim 6, wherein said CDMA communication method is carried out in a frequency hopping system.

8. A CDMA communication method as claimed in claim 6, wherein said CDMA communication system is carried out in a direct sequence system.

9. A CDMA communication method as claimed in claim 6, wherein the step of assigning said reverse spreading codes increases number of said reverse spreading codes when the traffic in said reverse channel is much, the step of assigning said reverse spreading codes decreasing the number of said reverse spreading codes when the traffic in said reverse channel is little.

10. A method as claimed in claim 6, wherein the step of assigning said forward spreading codes increases number of said forward spreading codes when the traffic in said forward channel is much, the step of assigning said forward spreading codes decreasing the number of said forward spreading codes when the traffic in said forward channel is little.

11. A code division multiple access (CDMA) communication system comprising a mobile station and a base station which communicate with each other using a common frequency band at a forward channel and a reverse channel,
said mobile station comprising:
mobile detecting means for detecting traffic in said reverse channel to produce a reverse traffic detected signal indicative of the traffic in said reverse channel; and
mobile assigning means for assigning reverse spreading codes to said reverse channel, said mobile assigning means making, in response to said reverse traffic detected signal, the number of said reverse spreading codes change,
said base station comprising;
base detecting means for detecting traffic in said forward channel to produce a forward traffic detected signal indicative of the traffic in said forward channel; and
base assigning means for assigning forward spreading codes to said forward channel, said base assigning means making, in response to said forward traffic detected signal, the number of said forward spreading code change.

12. A CDMA communication system as claimed in claim 11, wherein said CDMA communication system is a frequency hopping system.

13. A CDMA communication system as claimed in claim 11, wherein said CDMA communication system is a direct sequence system.

14. A CDMA communication system as claimed in claim 11, wherein said mobile assigning means increases number of said reverse spreading codes when the traffic in said reverse channel is much, said mobile assigning means decreasing the number of said reverse spreading codes when the traffic in said reverse channel is little.

15. A CDMA communication system as claimed in claim 11, wherein said base assigning means increases number of said forward spreading codes when the traffic in said forward channel is much, said base assigning means decreasing the number of said forward spreading codes when the traffic in said forward channel is little.

16. A method of communicating between a mobile station and a base station in a code division multiple access (CDMA) communication system using a common frequency band at a forward channel and a reverse channel, said method comprising the steps of:
detecting, in said mobile station, traffic in said reverse channel to produce a reverse traffic detected signal indicative of the traffic in said reverse channel;
assigning, in said mobile station, reverse spreading codes to said reverse channel to make, in response to said reverse traffic detected signal, number of said reverse spreading codes change;
detecting, in said base station, traffic in said forward channel to produce a forward traffic detected signal indicative of the traffic in said forward channel; and
assigning, in said base station, forward spreading codes to said forward channel to make, in response to said forward traffic detected signal, number of said forward spreading code change.

17. A method as claimed in claim 16, wherein said CDMA communication system is a frequency hopping system.

18. A method as claimed in claim 16, wherein said CDMA communication system is a direct sequence system.

19. A method as claimed in claim 16, wherein the step of assigning said reverse spreading codes increases number of said reverse spreading codes when the traffic in said reverse channel is much, the step of assigning said reverse spreading codes decreasing the number of said reverse spreading codes when the traffic in said reverse channel is little.

20. A method as claimed in claim 16, wherein the step of assigning said forward spreading codes increases number of said forward spreading codes when the traffic in said forward channel is much, the step of assigning said forward spreading codes decreasing the number of said forward spreading codes when the traffic in said forward channel is little.

21. A mobile station for use in a code division multiple access (CDMA) communication system comprising a base station which communicates with said mobile station using a common frequency band at a forward channel and a reverse channel, said mobile station comprising:
detecting means for detecting traffic in said reverse channel to produce a detected signal indicative of the traffic in said reverse channel; and
assigning means for assigning reverse spreading codes to said reverse channel, said assigning means making, in response to said detected signal, the number of said reverse spreading codes change.

22. A mobile station as claimed in claim 21, wherein said CDMA communication system is a frequency hopping system.

23. A mobile station as claimed in claim 21, wherein said CDMA communication system is a direct sequence system.

24. A mobile station as claimed in claim 21, wherein said assigning means increases number of said reverse spreading codes when the traffic in said reverse channel is much, said assigning means decreasing the number of said reverse spreading codes when the traffic in said reverse channel is little.

25. A base station for use in a code division multiple access (CDMA) communication system comprising a mobile station which communicates with said base station using a common frequency band at a forward channel and a reverse channel, said base station comprising: detecting means for detecting traffic in said forward channel to produce a detected signal indicative of the traffic in said forward channel; and
assigning means for assigning forward spreading codes to said forward channel, said assigning means making, in response to said forward traffic detected signal, the number of said forward spreading code change.

26. A base station as claimed in claim 25, wherein said CDMA communication system is a frequency hopping system.

27. A base station as claimed in claim 25, wherein said CDMA communication system is a direct sequence system.

28. A base station as claimed in claim 25, wherein said assigning means increases number of said forward spreading codes when the traffic in said forward channel is much, said assigning means decreasing the number of said forward spreading codes when the traffic in said forward channel is little.

29. A method of assigning reverse spreading codes in a mobile station for use in a code division multiple access (CDMA) communication system using a common frequency band at a forward channel and a reverse channel, said method comprising the steps of:
detecting traffic in said reverse channel to produce a detected signal indicative of the traffic in said reverse channel; and
assigning, in response to said detected signal, said reverse spreading codes to said reverse channel so as to make number of said reverse spreading codes change.

30. A method as claimed in claim 29, wherein said CDMA communication system is a frequency hopping system.

31. A method as claimed in claim 29, wherein said CDMA communication system is a direct sequence system.

32. A method as claimed in claim 29, wherein the step of assigning said reverse spreading codes increases number of said reverse spreading codes when the traffic in said reverse channel is much, the step of assigning said reverse spreading codes decreasing the number of said reverse spreading codes when the traffic in said reverse channel is little.

33. A method of assigning forward spreading codes in a base station for use in a code division multiple access (CDMA) communication system using a common frequency band at a forward channel and a reverse channel, said method comprising the steps of:
detecting traffic in said forward channel to produce a detected signal indicative of the traffic in said forward channel; and
assigning, in response to said detected signal, said forward spreading codes to said forward channel so as make number of said forward spreading code change.

34. A method as claimed in claim 33, wherein said CDMA communication system is a frequency hopping system.

35. A method as claimed in claim 33, wherein said CDMA communication system is a direct sequence system.

36. A method as claimed in claim 33, wherein the step of assigning said forward spreading codes increases number of said forward spreading codes when the traffic in said forward channel is much, the step of assigning said forward spreading codes decreasing the number of said forward spreading codes when the traffic in said forward channel is little.
